(19) United States
(12) Patent Application Publication
(10) Pub. No.: US 2003/0207690 A1
(43) Pub. Date: Nov. 6, 2003

(54) Method and apparatus for placing a dispatch call

(76) Inventor: Jheroen P. Dorenbosch, Paradise, TX (US)

Correspondence Address: MOTOROLA, INC., 1303 EAST ALGONQUIN ROAD, IL01/3RD, SCHAUMBURG, IL, 60196

(21) Appl. No.: 10/137,137

(22) Filed: May 1, 2002

(51) Int. Cl. H04Q 7/20

(52) U.S. Cl. 455/445; 455/518

(57) ABSTRACT

In order to alleviate network congestion, replication of packets is performed after the packets are received over a wide-area network (250). In particular, a voice packet received from a particular remote unit (201) by a particular base station (211) will be replicated, once for each downlink replicator involved in the call. These voice packets will be transmitted over the wide-area network (250) and will be received by the downlink replicators, again replicated, and transmitted to the appropriate base stations (212-215) where they are provided to their respective remote units (202-206).

### FIELD OF THE INVENTION

The present invention relates generally to cellular communication systems and in particular, to a method and apparatus for placing a dispatch call within such cellular communication systems.

### BACKGROUND OF THE INVENTION

Unlike standard interconnect services provided by today's cellular systems, a dispatch group call service enables a user to communicate with a group of people simultaneously and instantaneously, usually by depressing a push-to-talk (PTT) button. Using a cellular communication system's standard interconnect services would not allow such a call to occur instantaneously since either a telephone number would need to be dialed for a three-way call or arrangements would need to be made to setup a conference call.

Likewise, the dispatch service enables a user to communicate with another user quickly and spontaneously. This feature is ideal for two people who are working together but are unable to speak with one another directly such as two people working in concert but in different parts of a building. Where a wireless telephone call is more appropriate for a conversation, short messages between two people as they work are better facilitated by the dispatch call service.

Currently, group call services are highly inefficient when the group call participants are located in multiple cities connected by a wide-area network (WAN). More particularly, during a group call, multiple voice packets are transmitted over the WAN network, taking up valuable system resources. This is illustrated in FIG. 1. As shown, remote unit 101 is placing a dispatch call to remote units 102-105. Remote unit 101 transmits uplink voice packets to base station 111, which are forwarded to dispatch application processor (DAP) 119 which controls the call. Replication of the voice packets takes place at DAP 119 and multiple copies of the voice packet are then transmitted through WAN 100 to the appropriate DAPs 120-121. The voice packets are transmitted to their respective base stations 112-114 and ultimately to their destination remote units 102-105.

As is evident, a single dispatch call causes a high rate of network traffic. In particular, a group call now requires a single voice packet to be replicated for each “listener” and to be transferred over WAN 100, taking up valuable bandwidth. Thus, if there exists N call participants, each voice packet is replicated N times and then transmitted over WAN 100. Therefore, a need exists for a method and apparatus for placing a group call that allows for a more efficient use of a wide-area network.

### BRIEF DESCRIPTION OF THE DRAWINGS

FIG. 1 is a block diagram of a prior art communication system.

FIG. 2 is a block diagram of a communication system in accordance with the preferred embodiment of the present invention.

FIG. 3 is a block diagram of a packet replicator in accordance with the preferred embodiment of the present invention.

FIG. 4 is a flow chart showing operation of the communication system of FIG. 2 in accordance with the preferred embodiment of the present invention.

FIG. 5 is a flow chart showing operation of a replicator of FIG. 3 in accordance with the preferred embodiment of the present invention.

### DETAILED DESCRIPTION OF THE DRAWINGS

To address the above-mentioned need, a method and apparatus for providing dispatch service within a communication system is provided herein. In order to alleviate network congestion, replication of packets is performed after the packets are received over a wide-area network. In particular, a voice packet received by a particular base station will be replicated, once for each downlink replicator involved in the call. These voice packets will be transmitted over the wide-area network and will be received by the downlink replicators, again replicated, and transmitted to the appropriate base stations where they are provided to their respective remote units. Because packet replication additionally takes place after voice packets are received over the wide-area network, network congestion is greatly reduced.

The present invention encompasses a method comprising the steps of receiving a voice or data packet and performing a first replication on the packet to produce a first plurality of packets. The first plurality of packets are transmitted over a network and a second replication is performed on the first plurality of packets to produce a second plurality of packets. The second plurality of packets are then transmitted to a plurality of remote units involved in a call.

The present invention additionally encompasses a method comprising the steps of receiving a voice or data packet and determining where the packet originated. The packet is then replicated a number of times based on where the packet originated.

The present invention additionally encompasses an apparatus comprising means for receiving a voice or data packet, means for determining where the packet originated, and means for replicating the packet a number of times, wherein the number of times the packet is replicated is based on where the packet originated.

The present invention additionally encompasses an apparatus comprising a controller having a voice or data packet as an input and outputting the packet to replication circuitry and replication circuitry having the packet as an input and outputting a number of replicated packets, wherein the replicated packets are output to a plurality of replicators over a wide-area network, where they are again replicated and forwarded to remote units involved in a group call.

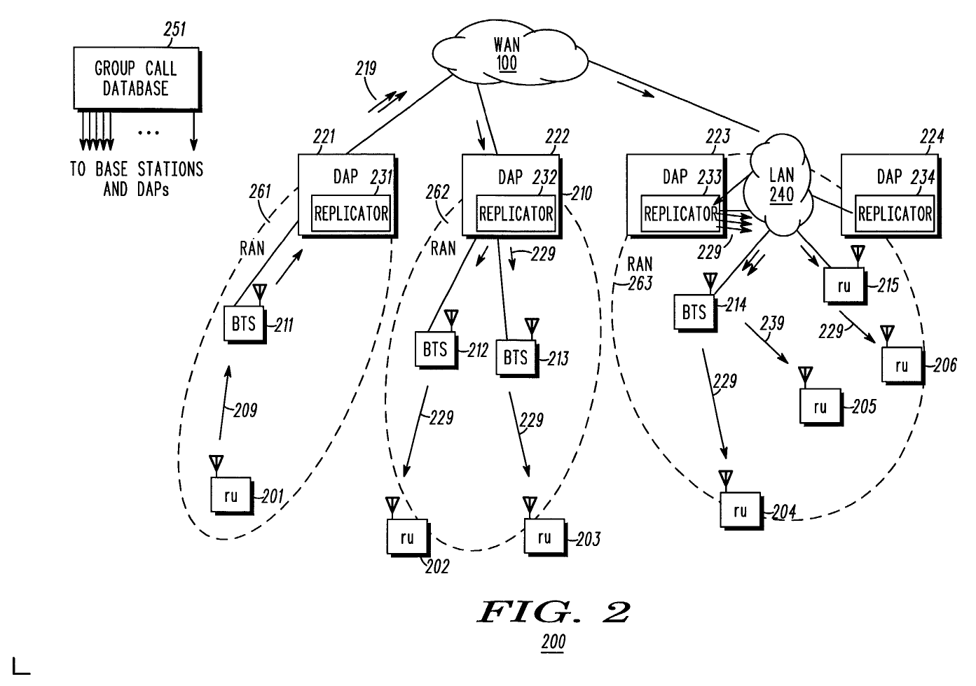

Turning now to the drawings, wherein like numerals designate like components, FIG. 2 is a block diagram of communication system 200 in accordance with the preferred embodiment of the present invention. In the preferred embodiment of the present invention, communication system 200 utilizes the Motorola Inc. iDEN system protocol, but in alternate embodiments communication system 200 may utilize other analog or digital cellular communication system protocols capable of supporting group call operation. Such protocols include, but are not limited to, the next generation Global System for Mobile Communications (GSM) protocol, or the CDMA system protocol as described in “Personal Station-Base Station Compatibility Requirements for 1.8 to 2.0 GHz Code Division Multiple Access (CDMA) Personal Communication Systems” (American National Standards Institute (ANSI) J-STD-008).

Communication system 200 includes group-call database 251 (or Group Call Register (GCR) 251 in GSM systems) coupled to Radio Access Networks (RANs) 261-263. In the preferred embodiment of the present invention, RANs 261-263 exists in separate cities (e.g., Chicago/Los Angeles/Paris). As shown, all RANs are connected via WAN 250. Each RAN 261-263 comprises a plurality of remote, or mobile units (RUs) 201-206, at least one Base Transceiver Station (BTS) 211-215, and at least one call coordinator. In the preferred embodiment the call coordinator is a Dispatch Application Processor (DAP) 221-224. The infrastructure elements within each RAN are connected via one or more local networks such as the Local Area Network (LAN) 240. In a RAN with more than one DAP the serving of remote units is load-balanced over each DAP. For example, in FIG. 2 remote units 204 and 205 may be served by DAP 223 and remote unit 206 may be served by DAP 224. Although not shown, RANs 261-263 additionally include well known network elements such as Mobile Switching Centers (MSCs), Centralized Base Station Controllers (CBSCs) in a circuit switch network, or such as Multiple Control Unit (MCUs) in a CDMA system, and Radio Network Controller (RNCs), Gatekeepers (GKs) Gateway GSNs (GGSNs) and Gateways (GWs) in a packet switch network. It is contemplated that network elements within communication system 200 are configured in well known manners with processors, memories, instruction sets, and the like, which function in any suitable manner to perform the function set forth herein.

Base stations 211-215 are capable of communicating with remote units 201-206 via over-the-air channels (not shown). Each over-the-air channel preferably comprises a unique frequency/timeslot (or code in a CDMA system), however, in alternate embodiments (e.g., multicast scenarios) over-the-air channels may be shared among remote units 201-206. In the preferred embodiment of the present invention base stations 211-215 are capable of providing dispatch services to remote units 201-206 over the over-the-air channels.

When a remote unit (e.g., remote unit 201) initially presses the push-to-talk button to initiate a group call, a PTT_on message is sent to serving base station 211 via an uplink communication signal, causing a set of resources to be allocated. In particular, when remote unit 201 presses a push-to-talk button, the remote unit sends an origination message on an access channel comprising a PTT_on message indicating that the push-to-talk button has been depressed, along with an identification of a talk group. Base station 211 forwards the origination message to DAP 221, which becomes an anchor DAP for the call. The anchor DAP 221 then accesses group-database 251, and provides database 251 with a talk-group identification. Database 251 then uses the talk-group identification to determine a list of member remote units to be included in the group call and provides this information to DAP 221. (Alternatively, the origination message may also contain the list of remote units to be included). DAP 221 determines a location of each remote unit in the talk group. Location determination for a remote unit is known in the art, and can be accomplished by accessing a Home Location Register (HLR) (not shown) or a SIP registrar (not shown). Next, DAP 221 determines which RANs contains at least one remote unit that is in the talk group. For each RAN DAP 221 then selects a single DAP (relay DAP) in that RAN that will relay the talk group call.

Selection of a relay DAP is non-trivial. In the preferred embodiment, the location determination is done by querying the HLRs of remote units to be included. The HLR returns the ID of the DAP that is currently serving the remote unit. For each serving DAP, the DAP 221 obtains the RAN of that DAP via a configuration database (not shown). Through this process, the DAP 221 obtains the RAN of each remote unit to be included in the call. If a remote unit is in the same RAN as DAP 221, DAP 221 will anchor the group call for that remote unit. DAP 221 sorts the remaining remote units by RAN to determine the number of remote units in each RAN. If the RAN contains a single remote unit, the DAP in that RAN serving the remote unit is selected as the relay DAP. If the RAN contains a plurality of remote units, the DAP 221 sorts the remote units in that RAN by serving DAP. The serving DAP that serves most remote units is selected as the relay DAP for that RAN. This information is then provided to the various DAPs serving the members of the talk group.

Thus, the pressing of the push-to-talk button results in database 251 determining a location for each member of the talk group and notifying DAPs that are serving members of the talk group of the call. For example, if remote unit 201 initiates a group call where remote units 202-206 are to be included in the call, DAP 221 becomes the anchor DAP. By sorting remote units by RAN, the anchor DAP determines that RAN 262 contains two remote units served by DAP 222 and that RAN 263 contains three remote units; two of which are served by DAP 223 and one by DAP 224. The anchor DAP 221 selects DAPs 222 and 223 as relay DAPs. In alternative embodiments, the location query may result in the knowledge of a Visited Location Register serving a remote unit, a SGSN, a Gateway or a GGSN serving the remote unit, a URL that can be used to reach the remote unit or a geographic location. Prior art methods can then be used to map this information on a specific RAN, sort remote units by RAN and assign a relay in each RAN.

In order to facilitate dispatch operation across RANs, communication system 200 includes packet replicators 231-234 at various network positions. As shown, DAPs 221-224 comprise packet replicators 231-234, respectively. The replicator comprised in a relay DAP will be referred to herein as a relay replicator. The replicator comprised in an anchor DAP will be referred to herein as an anchor replicator.

In the preferred embodiment of the present invention, the DAPs 221-224 notify replicators 231-234 of all remote units 201-206 involved in the dispatch call that currently reside under the replicator. However, in an alternate embodiment of the present invention the anchor DAP provides a list of all remote units involved in the call to each replicators 231-234. Replicators 231-234 can then determine those remote units residing under them. Additionally, although replicators are shown being internal to all DAPs, in alternate embodiments the replicators may be separate from the DAPs, still being controlled by a DAP.

In a dispatch group call, at any time communication system 200 only allows a single talker. For example in FIG. 2, when remote unit 201 is the talker, a voice packet 209 is transmitted from remote unit 201 to its base station 211. Base stations 211 pass the voice packets to its DAPs 221 where it enters replicator 231. Replicator 231 serves to perform a first replication of the voice packet. As discussed above, in prior art systems, the replicator uses the list of remote members to make one copy of each voice packet for each target remote unit an passes the packet to appropriate DAPs, where they are passed via the appropriate base stations to the member remote units. This causes a large amount of traffic to be transmitted over WAN 250. In order to solve this problem, in the preferred embodiment of the present invention replication is done in stages, in the first replication stage, a replicator makes a single replica for one or more other RANs involved in the group call and forwards the replica over WAN 250 to relay replicators involved in the call. In a second stage, each relay replicator performs a second replication, replicating downlink voice packets that are destined to remote units in its RAN.

Thus in accordance with the preferred embodiment of the present invention, fewer replicated voice packets are passed over WAN 250, greatly reducing network traffic. For example, where prior-art systems passed a copy of the voice packet for each remote unit involved in the call, in the preferred embodiment of the present invention, a single copy of the voice packet is passed to each RAN involved in the call. Thus, during operation, voice packets are transmitted from remote units 201-206 to their respective base stations 211-215. Base stations 211-215 pass the voice packets to their respective anchor or relay replicators 231-234 in their RAN. Replicators 231-234 serve to replicate the voice packet and pass only one packet to each appropriate anchor or relay replicator, where they are again replicated and passed to the appropriate base stations.

This is shown in FIG. 2. In this example, remote units 201-206 are involved in the dispatch call with remote unit 201 currently transmitting uplink voice packets. Remote unit 201 passes voice packet 209 to base station 211, which is subsequently passed to DAP 221 and its replicator 231. Instead of replicator 231 passing five copies (one for each “listening” remote unit) of the voice packet over the WAN, in the preferred embodiment of the present invention only two copies are passed over the WAN, one for each relay replicator 232-233 involved in the call. In other words, a single copy of voice packet 209 is passed to replicator 232, and another single copy is passed to replicator 233. Replicators 232-233 again replicate packet 209 (one for each “listening” remote unit) and pass the replicated packet to each of the appropriate base stations 212-215, where it is eventually transmitted to remote units 202-206. It should be noted that although the above embodiments were described with respect to voice packets, one of ordinary skill in the art will recognize that a similar technique can be utilized to transmit data packets. For example, the above techniques can be utilized to replicated signaling messages for the particular call as described above.

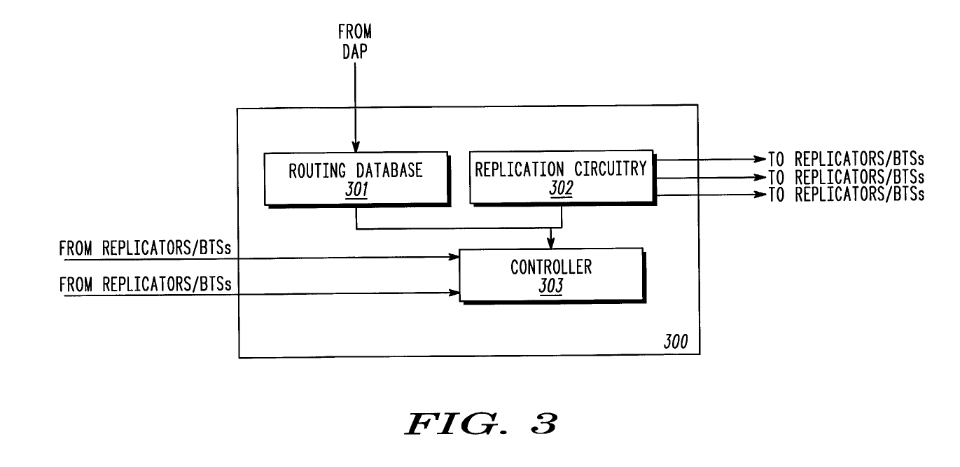

FIG. 3 is a block diagram of a packet replicator 300 in accordance with the preferred embodiment of the present invention. Replicator 300 comprises routing database 301, means for replicating a packet (replication circuitry 302), and means for receiving a packet and determining where the packet originated (controller 303). During operation, routing database 301 is provided all remote units 201-206 that currently reside under the replicator and anchor/relay replicators 231-233 involved in the dispatch call. In particular, routing database 301 is provided with a talk-group identifier, and those remote units and replicators that are to be provided a replicated voice packet when one is received from a remote unit or base station involved in the dispatch call. Table 1 illustrates the contents of routing database 301 in accordance with the preferred embodiment of the present invention for replicator 232 in FIG. 2.

TABLE 1
Routing Database

| Talk-Group Identifier | Route to remote units | Route to replicators |
|---|---|---|
| 1 | Remote units 202, 203 | Replicators 231, 233 |

As shown, routing database 301 is populated with a particular talk-group identifier along with routing information. Whenever a voice packet is received from a remote unit directly coupled to the replicator, the packet will be replicated and routed to the particular replicators on the list. Similarly, whenever a voice packet is received from a particular replicator, the voice packet will be replicated and transmitted to the particular remote units on the list.

In an alternative embodiment, a relay replicator may be instructed not to replicate a copy received from a directly coupled remote unit to multiple other replicators. Instead, the relay replicator may be programmed to send a single copy to the anchor replicator, which is then programmed to do a first stage replication and send a single copy of voice packet 209 to each remaining relay replicator.

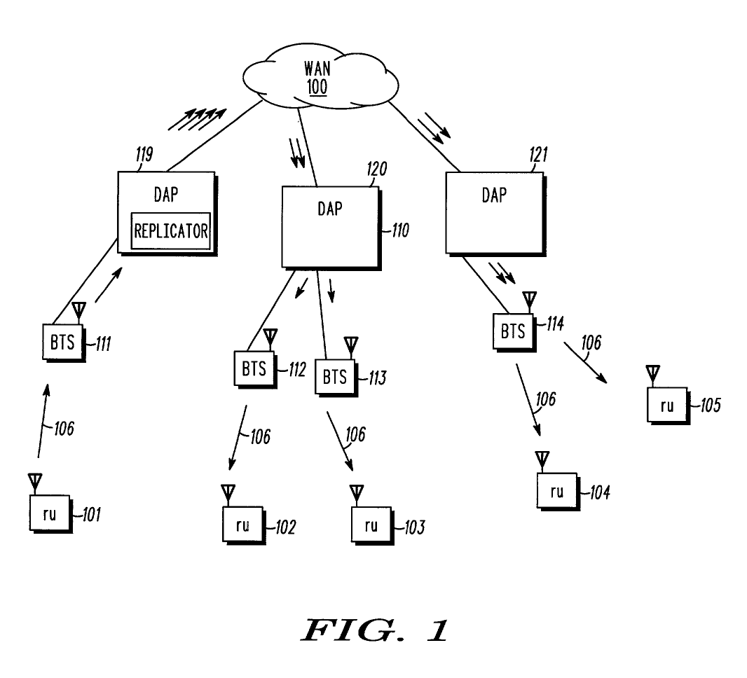

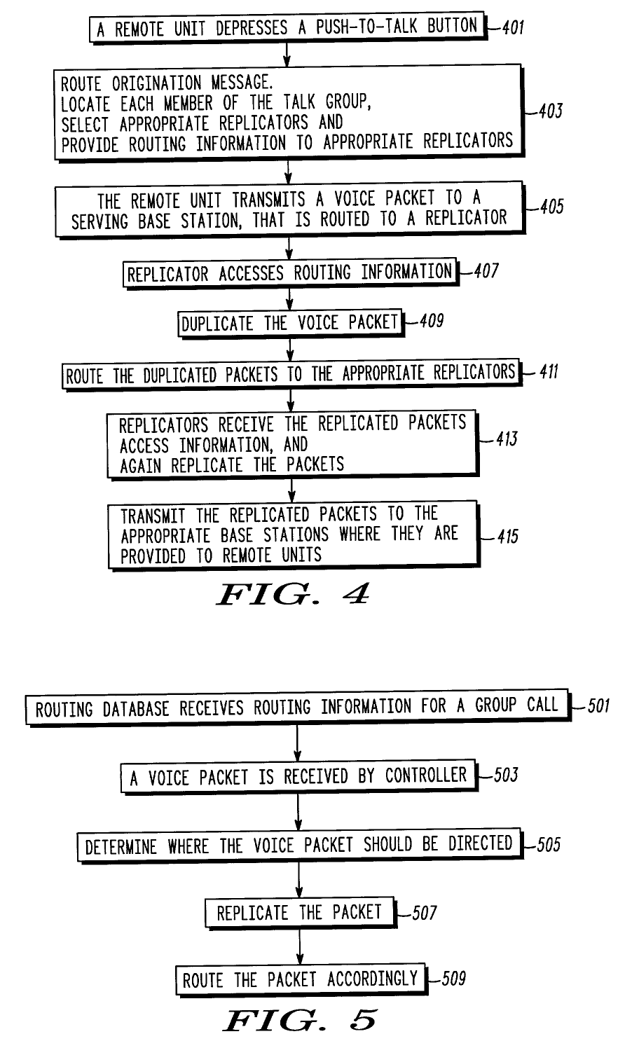

FIG. 4 is a flow chart showing operation of the communication system of FIG. 1 in accordance with the preferred embodiment of the present invention. For the following discussion, remote unit 201 initiates a group call between remote units 201-206. As shown in FIG. 2, remote unit 201 is within a first RAN 261, while remote units 202-203, and 204-206 exist within a second and third RAN, 262 and 263 respectively. As discussed above, each RAN may be located in a separate city.

The logic flow begins at step 401 where remote unit 201 depresses a push-to-talk button. As discussed above, this causes a message to be sent to serving base station 211 via an uplink communication signal. The message comprises an identification of the talk group. At step 403, the message is routed to a call coordinator (DAP 221). Call coordinator DAP 221 uses group-call database 251 to identify and locate each member of the talk group, selects anchor and relay replicators and provides replicators 231-234 routing information for packets received during the call. As discussed above, each replicator will receive instructions, or routing information, on where to route replicated voice packets received as part of the dispatch call.

At step 405 remote unit 201 transmits a voice packet 209 to base station 211, that is routed to replicator 231. In a first stage, replicator 231 accesses routing information (step 407), determines a number of replicators involved in the call and duplicates the voice packet 209 based on the number (step 409), and routes the duplicated packets 219 to the appropriate relay replicators 232-233 (step 411). Replicators 232-233 receive the replicated packets, access routing information, and in a second stage again replicate the packets, this time based on a number of remote units involved in the call (step 413), and transmit the replicated packets (229) to the appropriate base stations where they are provided to remote units 202-206 (step 415). It should be noted that in the preferred embodiment of the present invention each packet transmitted by base stations 211-215 is transmitted over a separate over-the-air channel (frequency/timeslot, or code in a CDMA system), however, in multicast scenarios where multiple remote units involved in the call are served by a single base station, a single channel may be used to broadcast the downlink transmissions to the remote units.

FIG. 5 is a flow chart showing operation of a replicator of FIG. 3 in accordance with the preferred embodiment of the present invention. The logic flow begins at step 501 where routing database 301 receives routing information for a group call. As discussed above, the routing information provides instructions on where to route voice packets for a particular dispatch call. In the preferred embodiment of the present invention, the routing of voice packets depends on both a group-call identification and where the voice packet originated.

Continuing, at step 503 a voice packet is received by controller 303. Each voice packet received will contain both “from” information, along with a dispatch call identification. This information tells the replicator where the packet was received from along with associating the packet with a particular group call. Controller 303 accesses routing database 301 and determines where the voice packet should be directed (step 505). Controller 303 then replicates the packets (step 507) via replication circuitry 302, and routes the packets accordingly (step 509). The outgoing packets will additionally have “from” information identifying the particular replicator performing the replication, along with group call information within the packets.

In the preferred embodiment of the present invention routing is based both on where the packet originated, and the group call identifier. For example, with respect to Table 1, above, if a replicator received a voice packet having a “1” as the talk group identifier, the replicator will know that the packet should be replicated and transmitted to remote units 202 and 203, or replicated and send to replicators 231 and 233. In order to determine whether to send voice packets to the base stations or the DAPs, the replicator determines where the packet originated. If the packet originated from a base station, then the packet is replicated and routed to the appropriate replicators, however, if the packet originated from a replicator (via the WAN), then the packet is replicated and routed to the appropriate base stations. Thus, in accordance with the preferred embodiment of the present invention, the packet is replicated a number of times based on where the packet originated. Particularly, if the packet originated from a replicator, then the packet is replicated a first number of times and transmitted to a plurality of base stations. If, however, the packet originated from a base station, then the packet is replicated a second number of times and transmitted to a plurality of replicators over a WAN.

While the invention has been particularly shown and described with reference to a particular embodiment, it will be understood by those skilled in the art that various changes in form and details may be made therein without departing from the spirit and scope of the invention. For example, although the above embodiments were described for a dispatch call, the same two-stage replication can be used for a full-duplex group call, such as a conference call between cellular phone remote units. While in a dispatch call, at any time, there is only a single talker that produces a single stream of voice packets that is replicated, in a full-duplex group call there can be multiple simultaneous talkers that each produce a stream of voice packets. Again, a call controller obtains a list of the member remote units in a call, determines the RAN for each remote and selects a single replicator in each RAN that contains a remote unit. The replicators 231-341 in a full-duplex group call will function exactly as the replicator 330. A call controller (221-224) programs routing information stored in the routing databases of the replicators 231-234. It is intended that such changes come within the scope of the following claims.

1. A method comprising the steps of:
obtaining a list of member remote units in a call;
determining for each remote unit in the call, a RAN that contains the remote unit;
selecting a plurality of replicators such that a single replicator is associated with each RAN;
receiving a voice or data packet;
performing a first replication on the packet to produce a first plurality of packets;
transmitting the first plurality of packets over a network;
performing a second replication of the first plurality of packets to produce a second plurality of packets; and
transmitting the second plurality of packets to the at least one remote unit in the call in the RAN associated with the second replicator.

2. The method of claim 1 wherein the step of performing the first replication comprises the steps of:
determining a plurality of replicators involved in the call; and
replicating the packet based on the plurality of replicators involved in the call.

3. The method of claim 2 wherein the step of performing the second replication comprises the steps of:
determining the plurality of remote units involved in the call; and
replicating the packet the first plurality of packets based on the plurality of remote units involved in the call.

4. The method of claim 1 wherein the step of performing the second replication comprises the steps of:
determining a plurality of remote units involved in the call; and
replicating the packet the first plurality of packets based on the plurality of remote units involved in the call.

5. The method of claim 1 wherein the step of transmitting the first plurality of packets over the network comprises the steps of transmitting the first plurality of packets over a wide-area network.

6. The method of claim 1 wherein the step of transmitting the second plurality of packets comprises the step of transmitting the second plurality of packets to remote units over an over-the-air channel.

7. A method comprising the steps of:
receiving a voice or data packet;
determining where the packet originated; and
replicating the packet a number of times, wherein the number of times the packet is replicated is based on where the packet originated.

8. The method of claim 7 wherein the step of determining where the packet originated comprises the step of determining if the packet originated from a replicator or from a base station.

9. The method of claim 7 wherein the step of replicating the packet comprises the steps of:
determining if the packet originated from a replicator or from a base station; and
if the packet originated from the replicator, replicating the packet a first number of times and transmitting the replicated packets to a plurality of base stations; otherwise replicating the packet a second number of times and transmitting the replicated packets to a plurality of replicators.

10. An apparatus comprising:
means for receiving a voice or data packet;
means for determining where the packet originated; and
means for replicating the packet a number of times, wherein the number of times the packet is replicated is based on where the packet originated.

11. An apparatus comprising:
a controller having a voice or data packet as an input and outputting the packet to replication circuitry; and
replication circuitry having the packet as an input and outputting a number of replicated packets, wherein the replicated packets are output to a plurality of replicators over a wide-area network, where they are again replicated and forwarded to remote units involved in a group call.

12. The apparatus of claim 11 further comprising a routing database coupled to the replication circuitry.

13. The apparatus of claim 12 wherein the routing database comprises a talk-group identifier.

14. The apparatus of claim 13 wherein the routing database further comprises a plurality of remote units associated with the talk-group identifier.

15. The apparatus of claim 14 wherein the routing database further comprises the plurality of replicators associated with the talk-group identifier.

16. The apparatus of claim 11 wherein the data packet comprises a signaling message.
